(19) United States
(12) Patent Application Publication
(10) Pub. No.: US 2011/0018805 A1
(43) Pub. Date: Jan. 27, 2011

(54) LOCATION-DETECTING SYSTEM AND ARRANGEMENT METHOD THEREOF

(75) Inventors: Yu-Wei Liao, Taipei City (TW); Chien-Hsien Ho, Taipei City (TW)

Correspondence Address: COVENANT IP CONSULTING CO., P.O. BOX 34-306 TAIPEI CITY, TAIPEI, 10499, TW

(73) Assignee: QISDA CORPORATION, Taoyuan County (TW)

(21) Appl. No.: 12/838,490

(22) Filed: Jul. 18, 2010

(30) Foreign Application Priority Data
Jul. 21, 2009 (TW) 098124554

(51) Int. Cl. G06F 3/033

(52) U.S. Cl. 345/158

(57) ABSTRACT

The invention discloses a location-detecting system including an indication region, one of a camera unit and a light-emitting unit, and an optical device. The indication region is for indication of a target location thereon. One of the camera unit and the light-emitting unit is disposed at a first location of the indication region, and the optical device is disposed at a second location of the indication region and corresponding to one of the camera unit and the light-emitting unit. The optical device is for forming one of a specular reflection camera unit and a specular reflection light-emitting unit, wherein the specular reflection camera unit originates from the camera unit, and the specular reflection light-emitting unit originates from the light-emitting unit.

### BACKGROUND OF THE INVENTION

1. Field of the Invention

The present invention relates to a location-detecting system and an arrangement method thereof for enhancing the accuracy of detection locations.

2. Description of the Prior Art

With the touch system becoming developed, it will be the trend in the future for a device to have a large-scaled screen and a multi-touch function. At present, the optical touch system has the features of low cost and easy construction when compared to other types of touch systems, such as the resistance type, the capacitance type, the ultrasonic type, and the projection type. However, there is a dead corner in the whole touch region caused by the design problem of the system, and the dead corner may result in a false judgment of the system, even a void judgment.

Please refer to FIG. 1A and FIG. 1B which illustrate the schematic diagrams of an optical touch system 1 in the prior art. The optical touch system 1 includes a touch panel 10, camera units 12, and light-emitting units 11. The light-emitting units 11 are disposed at three sides of the touch panel 10, while the camera units 12 are disposed at two ends of the side, where no light-emitting unit is constructed, of the touch panel 10.

It is observed from FIG. 1A that if the touch point 13 approaches the camera unit 12 at the corner of the touch panel 10 more, the dark region D appearing on the light-emitting unit 11 relative to the camera unit 12 will become bigger. That is, more light will be blocked as the touch point 13 approaches the camera unit 12 at the corner of the touch panel 10 more; thus, it will cause the system to have a quite worse resolution when optical touch system 1 determines the location of the touch point 13 at the corner of the touch panel 10, and the system is even unable to calculate the accurate location of the touch point 13 when the dark region is out of the light-emitting unit 11.

Additionally, as shown in FIG. 1B, another drawback of the traditional optical touch system is that when there are at lest two touch points, e.g. points (14, 15), at the same time, the dark region D1 corresponding to the touch point 14 close to the corner of the touch panel 10 would overlap the dark region D2 corresponding to the touch point 15 easily; thus, the accurate location of the overlapped dark region D2 can not be determined, resulting in the problem of a false judgment, even a void judgment.

Accordingly, if the above-mentioned problems of the traditional optical touch system are resolved, it will be advantageous to the practice and promotion of the optical touch system.

### SUMMARY OF THE INVENTION

An aspect of the invention is to provide a location-detecting system.

According to an embodiment of the invention, the location-detecting system includes an indication region, one of a camera unit and a light-emitting unit, and an optical device. In practical applications, the optical device may be a plane mirror assembly which includes at least one plane mirror. Alternatively, the optical device may be a prism.

The indication region is for indicating a target location thereon. One of the camera unit and the light-emitting unit is disposed at a first location of the indication region. The optical device is disposed at a second location of the indication region and corresponding to one of the camera unit and the light-emitting unit. The optical device is for forming one of a specular reflection camera unit and a specular reflection light-emitting unit, wherein the specular reflection camera unit originates from the camera unit, and the specular reflection light-emitting unit originates from the light-emitting unit.

Another aspect of the invention is to provide an arrangement method of a location-detecting system. According to an embodiment of the invention, the method includes the following steps:
providing an indication region for indicating a target location thereon;
disposing one of a camera unit and a light-emitting unit at a first location of the indication region;
disposing an optical device at a second location of the indication region and corresponding to one of the camera unit and the light-emitting unit; and
forming one of a specular reflection camera unit and a specular reflection light-emitting unit, wherein the specular reflection camera unit originates from the camera unit, and the specular reflection light-emitting unit originates from the light-emitting unit.

Compared to the prior art, the present invention discloses that the optical device is disposed corresponding to one of the camera unit and the light-emitting unit so as to form one of the specular reflection camera unit and the specular reflection light-emitting unit; in this way, the effective optical path distance between the light source (or the camera unit) and the edge of the indication region, e.g. a touch screen, is increased. By use of the arrangement method of the location-detecting system, it avoids the problem of low resolution or even void reorganization once the touch point approaches the light-emitting unit (or the camera unit) at the corner of the indication region.

The advantage and spirit of the invention may be understood by the following recitations together with the appended drawings.

### BRIEF DESCRIPTION OF THE APPENDED DRAWINGS

FIG. 1A and FIG. 1B illustrate the schematic diagrams of an optical touch system in the prior art.

FIG. 2A illustrates the schematic diagram of the location-detecting system according to an embodiment of the invention.

FIG. 2B illustrates the schematic diagram of the location-detecting system according to another embodiment of the invention.

FIG. 3 illustrates the schematic diagram of the location-detecting system according to another embodiment of the invention.

FIGS. 4A to 4C illustrate the schematic side views of the optical device in different embodiments.

FIG. 5 illustrates the schematic diagram of the camera unit which includes plural modulized camera devices and the formation of the plural specular reflection camera devices.

FIG. 6 illustrates the flow chart of the arrangement method of the location-detecting system according to an embodiment of the invention.

### DETAILED DESCRIPTION OF THE INVENTION

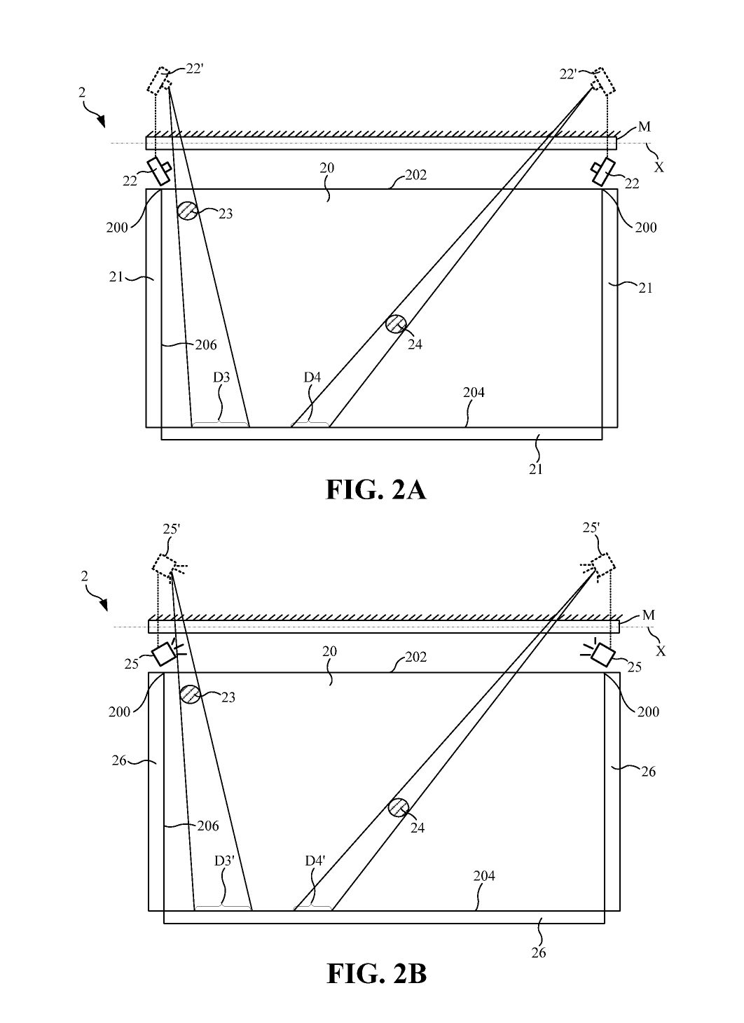

Please refer to FIG. 2A which illustrates the schematic diagram of the location-detecting system 2 according to an embodiment of the invention. As shown in FIG. 2A, the location-detecting system 2 includes the indication region 20, the light-emitting units 21, the camera units 22, and the optical device, e.g. the plane mirror M. The indication region 20 may be a touch panel of the optical touch system or an additional object disposed on an ordinary display panel. The indication region 20 is for indication of a target location for a user thereon, as the touch points (23, 24) shown in FIG. 2A. In manipulation, the user may use his finger or other indication devices, e.g. a touch pen, to indicate the target location on the indication region 20. In practical applications, the optical device may be a plane mirror assembly which includes at least one plane mirror. Additionally, the optical device may be a prism or other sorts of mirrors. The light-emitting unit in this embodiment takes a line light source as an example, but it may be a point light source or other sorts of light sources in another embodiment.

Each of the camera units 22 is disposed at a first location of the indication region 20, while the optical device is disposed at a second location of the indication region 20 and corresponding to each of the camera units 22. In this embodiment, the light-emitting units 21 are disposed at three sides of the indication region 20, while the two camera units 22 are disposed at two ends of the side, where no light-emitting unit is constructed, of the indication region 20. When a touch point is within the region, e.g. the indication region 20, enclosed by the light-emitting units 21 and the camera units 22, a dark region caused by blocking light by the finger of a user or other indication devices will appear on certain light-emitting unit 21, and the image of said certain light-emitting unit 21 under this condition will be captured by the camera unit 22 corresponding to said certain light-emitting unit 21; then, the system calculates the target location of the touch point on the indication region 20 based on the location of the dark region in the captured image.

As shown in the embodiment of FIG. 2A, the first location is the periphery at a corner 200 of the indication region 20. The corner 200 has a first edge 202, and the second location is on an axis X parallel to the first edge 202. It should be noted that the optical device in the embodiment is the plane mirror M in FIG. 2A, and the camera units 22 are disposed between the optical device and the indication region 20. In addition to the single plane mirror M, the optical device may be a plane mirror assembly, a prism, other sorts of mirrors, or a combination of these mirrors.

It should be particularly explained that the optical device is for forming the specular reflection camera units 22′ which originate from the camera units 22. Furthermore, how the image would be captured by the specular reflection camera units 22′ can be determined by the type of the optical device and the locations of the camera units 22.

Referring to FIG. 2A, after the specular reflection camera units 22′ originating from the camera units 22 are formed through the optical device, the image of each light-emitting unit 21 can be captured from where the corresponding specular reflection camera unit 22′ locates.

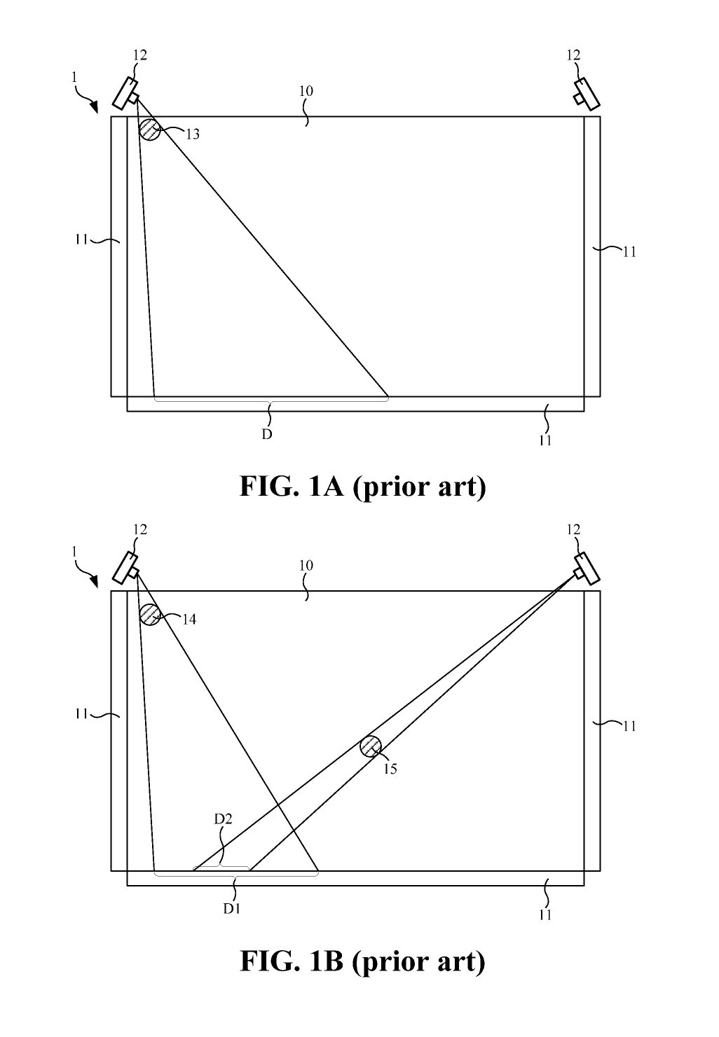

As mentioned above, the traditional optical touch system in the prior art as shown in FIG. 1A has the problem of a false judgment, even a void judgment. In comparison with the traditional system, it should be particularly explained according to the invention that by use of the optical device in a reflective way, the specular reflection camera unit 22′ is at a longer distance than the camera unit 22 from the target location on the indication region 20, and thus the effective optical path distance between the camera unit 22 and the target location on the indication region 20 is increased by means of the specular reflection camera unit 22′; in this way, the dark region appearing on the light-emitting unit 21 can be minimized, which particularly decreases the blocked light greatly when the touch point is at the corner of the indication region 20.

As shown in FIG. 2A, when the image of the lower light-emitting unit 21 is captured from where the two specular reflection camera units 22′ locat, the dark region D3 in the captured image will not overlap the dark region D4 corresponding to the touch point 24 even although the touch point 23 is located at the corner of the indication region 20; thus, it can effectively enhance the accuracy of determining respective locations of the touch points (23, 24).

Please refer to FIG. 2B which illustrates the schematic diagram of the location-detecting system 2 according to another embodiment of the invention.

The location-detecting system 2 of FIG. 2B differs from that of FIG. 2A in exchanging the dispositions of the light-emitting unit and the camera unit. Referring to FIG. 2B in detail, there are camera units 26 disposed along three sides of the indication region 20, while there are two light-emitting units 25 disposed at two ends of the side, where no camera unit is disposed, of the indication region 20. By comparing the designs of the systems in FIG. 2A and FIG. 2B, although the dispositions of the light-emitting unit and the camera unit are different, there is a common logic in determining the touch points; the logic is well known in this art and thus not described in more detail herein.

As shown in FIG. 2B, the optical device, e.g. the plane mirror M, is for forming the specular reflection light-emitting units 25′ which originate from the light-emitting units 25. Moreover, the specular reflection light-emitting unit 25′ is at a longer distance than the light-emitting unit 25 from the target location, i.e. the touch points (23, 24), on the indication region 20. Based on the same principle, the effective optical path distance between the light-emitting unit and the target location on the indication region 20 is increased by means of the specular reflection light-emitting 25′; in this way, the dark region appearing on the camera units 26 can be minimized. As shown in FIG. 2B, the dark region D3′ appearing on the lower camera unit 26 will not overlap the dark region D4′ corresponding to the touch point 24 even although the touch point 23 is located at the corner of the indication region 20; thus, it can effectively enhance the accuracy of determining respective locations of the touch points (23, 24).

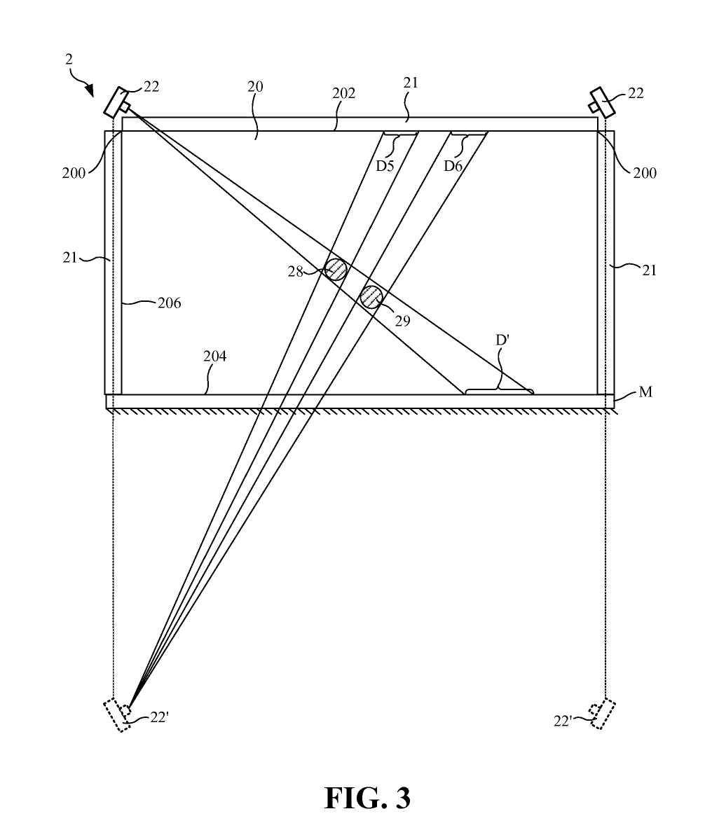

Please refer to FIG. 3 which illustrates the schematic diagram of the location-detecting system according to another embodiment of the invention.

In this embodiment, each of the camera units 22 is disposed at a first location of the indication region 20, i.e. the periphery at the corner 200 of the indication region 20. The corner 200 has a first edge 202, and the second location is a second edge 204 of the indication region 20, wherein the second edge 204 is opposite to the first edge 202. As shown in FIG. 3, the optical device is disposed along the second edge 204 of the indication region 20. The optical device in the embodiment is the plane mirror M. In addition to the single plane mirror M, the optical device may be a plane mirror assembly, a prism, or a combination of these mirrors.

Compared to FIG. 2A, it should be explained that since the distance between the camera unit 22 and the optical device in FIG. 3 is increased further, the optical device disposed along the second edge 204 can further increase the effective optical path distance between the camera unit and the target location on the indication region 20 by means of the specular reflection camera unit 22′, i.e. the touch points (28, 29); thus, it can further ensure the enhancement of the accuracy of determining respective locations of the touch points.

For example, if the image of the optical device, i.e. the plane mirror M, is captured from where the camera unit 22 locates, it is obvious that the dark region D′, appearing on the optical device and corresponding to the touch point 28, will overlap the dark region (not expressed) corresponding to the touch point 29; hence, it results in the problem of a false judgment, even a void judgment. However, if the image of the optical device is captured from where the specular reflection camera unit 22′ locates, the dark regions (D5, D6), appearing on the upper light-emitting unit 21 and corresponding to the touch points (28, 29) respectively, can be captured respectively.

In other words, the dark region D5 corresponding to the touch point 28 will not overlap the dark region D6 corresponding to the touch point 29 under this condition, and it can ensure the accuracy of determining respective locations of the touch points. To make FIG. 3 be understood easily, FIG. 3 only illustrates the captured dark regions for one of the two camera units.

It should be additionally explained that as the difference between the systems in FIG. 2A and FIG. 2B, the dispositions of the light-emitting unit and the camera unit in the system of FIG. 3 can be exchanged in this invention.

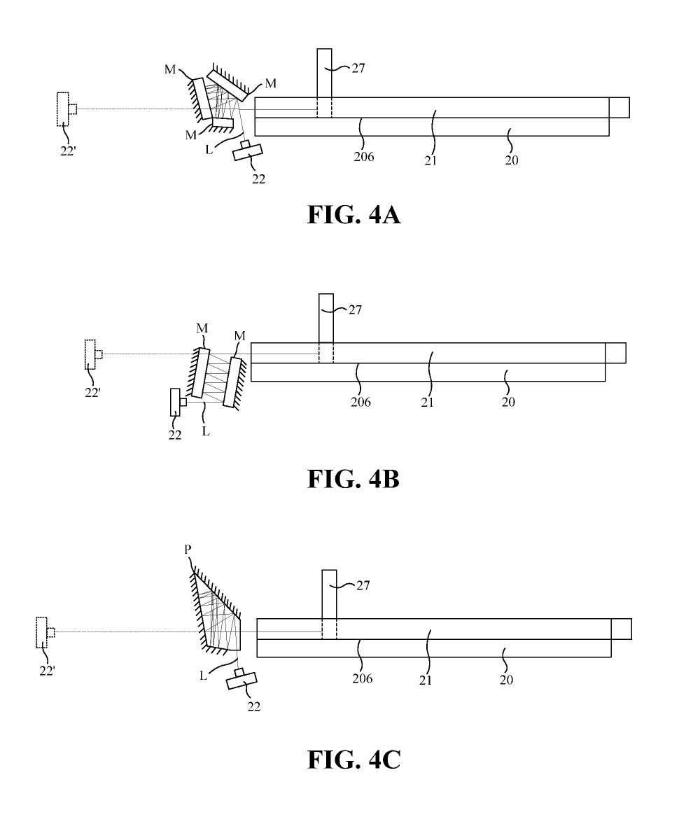

Please refer to FIGS. 4A to 4C which illustrate the schematic side views of the optical device in different embodiments in addition to the foregoing single plane mirror, wherein mark 27 means an indication object, e.g. fingers or other indication devices. It should be noted that the specular reflection camera unit 22′ (or a specular reflection light-emitting unit) in FIGS. 4A to 4C is formed on the extension direction of the edge 206 of the indication region 20, and the specular reflection camera unit 22′ is at a longer distance than the camera unit 22 from the indication object 27. In practical embodiments, whether the specular reflection camera unit (or the specular reflection light-emitting unit) is formed on the mentioned extension direction is determined by the disposition and the optical path of the optical device.

Referring to FIG. 4A, the optical device consists of a plane mirror assembly including three plane mirrors M arranged in a specific way. Thus, the optical path L resulted from the reflection of the camera unit 22 through the plane mirror assembly can form the specular reflection camera unit 22′.

Referring to FIG. 4B, the optical device consists of a plane mirror assembly including two plane mirrors M arranged in a specific way. Thus, the optical path L resulted from the reflection of the camera unit 22 through the plane mirror assembly can form the specular reflection camera unit 22′. It should be noted that because the optical path L in FIG. 4A is longer than that in FIG. 4B, the specular reflection camera unit 22′ in FIG. 4A is formed farther.

In addition to the plane mirror, the optical device in FIG. 4C may be a prism P; thus, the optical path L resulted from multiple reflections of the camera unit 22 inside the prism P can also form the specular reflection camera unit 22′. It should be noted that because the optical path L in FIG. 4C is longer than that in FIG. 4A, the specular reflection camera unit 22′ in FIG. 4C is formed farther.

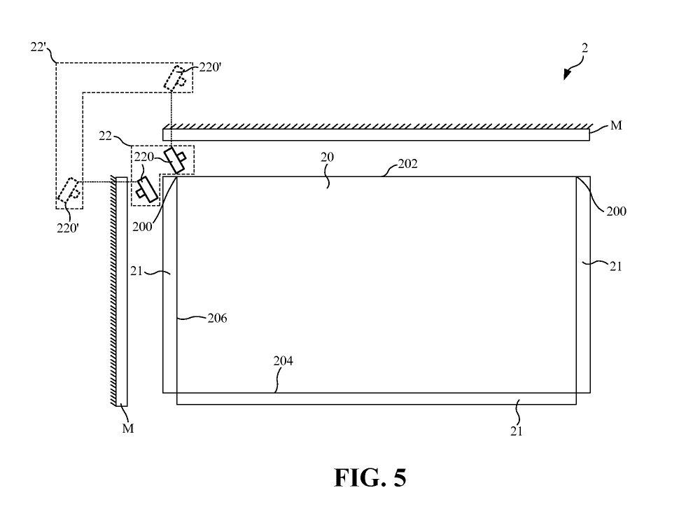

Additionally, in an embodiment, the camera unit may include plural modulized camera devices. Please refer to FIG. 5 which illustrates the schematic diagram of the camera unit 22 which includes two modulized camera devices 220 and the formation of two specular reflection camera devices 220′, wherein the optical device is corresponding to each of the camera devices 220. The optical device in FIG. 5 includes two plane mirrors M disposed outside the indication 20 and parallel to the two sides (202, 206) of the corner 200 for forming the specular reflection camera unit 22′ which includes the two specular reflection camera devices 220′.

Similarly, in the case that the locations of the light-emitting unit and the camera are exchanged, as described previously, the light-emitting unit may also include plural modulized light-emitting devices, and the optical device is corresponding to each of the plural light-emitting devices so as to form the specular reflection light-emitting unit which includes plural specular reflection light-emitting devices. It should be noted that the modulized light-emitting unit (or the camera unit) has advantages of simplified structure, less assembly errors, and easy assembly, etc.

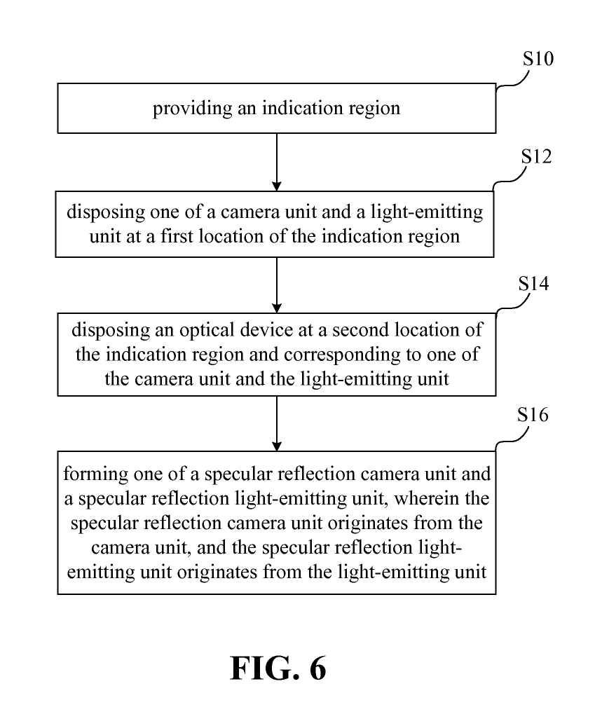

Another aspect of the invention is to provide an arrangement method of a location-detecting system. Please refer to FIG. 6 which illustrates the flow chart of the arrangement method of the location-detecting system according to an embodiment of the invention. Please refer to FIGS. 2A to 5 and related descriptions for full understanding of the invention.

In executing step S10, an indication region 20 is provided for indication of a target location thereon.

In executing step S12, one of a camera unit 22 and a light-emitting unit 25 is disposed at a first location of the indication region 20.

In executing step S14, an optical device is disposed at a second location of the indication region 20 and corresponding to one of the camera unit 22 and the light-emitting unit 25. In practical applications, the optical device may be a plane mirror assembly which includes at least one plane mirror. Additionally, the optical device may be a prism, other sorts of mirrors, or a combination of these mirrors.

In executing step S16, one of a specular reflection camera unit 22′ and a specular reflection light-emitting unit 25′ is formed, wherein the specular reflection camera unit 22′ originates from the camera unit 22, and the specular reflection light-emitting unit 25′ originates from the light-emitting unit 25.

Please refer to the embodiment in FIG. 2A and FIG. 2B. In this embodiment, the first location is the periphery at a corner 200 of the indication region 20. The corner 200 has a first edge 202, and the second location is on an axis X parallel to the first edge 202 and outside the indication region 20. One of the camera unit 22 and the light-emitting unit 25 is disposed between the optical device and the indication region 20.

Please refer to the embodiment in FIG. 3. In this embodiment, the first location is the periphery at a corner 200 of the indication region 20. The corner 200 has a first edge 202, and the second location is a second edge 204 of the indication region 20, wherein the second edge 204 is opposite to the first edge 202.

Please refer to the embodiments in FIGS. 4A to 4C. In these embodiments, the indication region 20 includes an edge 206; one of the specular reflection camera unit 22′ and the specular reflection light-emitting unit 25′ is formed on the extension direction of the edge 206.

It should be additionally noted that the light-emitting unit may include plural modulized light-emitting devices; the optical device is corresponding to each of the plural light-emitting devices so as to form the specular reflection light-emitting unit which includes plural specular reflection light-emitting devices. Similarly, the camera unit may include plural modulized camera devices; the optical device is corresponding to each of the plural camera devices so as to form the specular reflection camera unit which comprises plural specular reflection camera devices.

Compared to the prior art, the present invention discloses that the optical device is disposed corresponding to the camera unit or light-emitting unit so as to form the specular reflection camera unit or the specular reflection light-emitting unit; in this way, the effective optical path distance between the light source (or the camera unit) and the edge of the indication region, e.g. a touch screen, is increased. By use of the arrangement method of the location-detecting system, it avoids the problem of low resolution or even void reorganization once the touch point (e.g. where the finger contacts) approaches the light-emitting unit (or the camera unit) at the corner of the indication region. Furthermore, to modulize the light-emitting devices (or camera devices) has advantages of simplified structure, less assembly errors, and easy assembly, etc.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A location-detecting system, comprising:
an indication region for indicating a target location thereon;
one of a camera unit and a light-emitting unit disposed at a first location of the indication region; and
an optical device disposed at a second location of the indication region and corresponding to one of the camera unit and the light-emitting unit, the optical device being for forming one of a specular reflection camera unit and a specular reflection light-emitting unit, wherein the specular reflection camera unit originates from the camera unit, and the specular reflection light-emitting unit originates from the light-emitting unit.

2. The system of claim 1, wherein one of the specular reflection camera unit and the specular reflection light-emitting unit is at a longer distance than one of the camera unit and the light-emitting unit from the target location.

3. The system of claim 1, wherein the first location is the periphery at a corner of the indication region, the corner has a first edge, the second location is on a first axis parallel to the first edge, and one of the camera unit and the light-emitting unit is disposed between the optical device and the indication region.

4. The system of claim 3, wherein the optical device is a plane mirror assembly which comprises at least one plane mirror.

5. The system of claim 3, wherein the optical device is a prism.

6. The system of claim 1, wherein the first location is the periphery at a corner of the indication region, the corner has a first edge, the second location is a second edge of the indication region, and the second edge is opposite to the first edge.

7. The system of claim 6, wherein the optical device is a plane mirror assembly which comprises at least one plane mirror.

8. The system of claim 6, wherein the optical device is a prism.

9. The system of claim 1, wherein the camera unit comprises plural modulized camera devices, the optical device is corresponding to each of the plural camera devices so as to form the specular reflection camera unit which comprises plural specular reflection camera devices.

10. The system of claim 1, wherein the light-emitting unit comprises plural modulized light-emitting devices, the optical device is corresponding to each of the plural light-emitting devices so as to form the specular reflection light-emitting unit which comprises plural specular reflection light-emitting devices.

11. The system of claim 1, wherein the indication region comprises an edge, one of the specular reflection camera unit and the specular reflection light-emitting unit is formed on an extension direction of the edge.

12. An arrangement method of a location-detecting system, comprising the following steps:
providing an indication region for indicating a target location thereon;
disposing one of a camera unit and a light-emitting unit at a first location of the indication region;
disposing an optical device at a second location of the indication region and corresponding to one of the camera unit and the light-emitting unit; and
forming one of a specular reflection camera unit and a specular reflection light-emitting unit, wherein the specular reflection camera unit originates from the camera unit, and the specular reflection light-emitting unit originates from the light-emitting unit.

13. The method of claim 12, wherein one of the specular reflection camera unit and the specular reflection light-emitting unit is at a longer distance than one of the camera unit and the light-emitting unit from the target location.

14. The method of claim 12, wherein the first location is the periphery at a corner of the indication region, the corner has a first edge, the second location is on a first axis parallel to the first edge, and one of the camera unit and the light-emitting unit is disposed between the optical device and the indication region.

15. The method of claim 14, wherein the optical device is a plane mirror assembly which comprises at least one plane mirror.

16. The method of claim 14, wherein the optical device is a prism.

17. The method of claim 12, wherein the first location is the periphery at a corner of the indication region, the corner has a first edge, the second location is a second edge of the indication region, and the second edge is opposite to the first edge.

18. The method of claim 17, wherein the optical device is a plane mirror assembly which comprises at least one plane mirror.

19. The method of claim 17, wherein the optical device is a prism.

20. The method of claim 12, wherein the camera unit comprises plural modulized camera devices, the optical device is corresponding to each of the plural camera devices so as to form the specular reflection camera unit which comprises plural specular reflection camera devices.

21. The method of claim 12, wherein the light-emitting unit comprises plural modulized light-emitting devices, the optical device is corresponding to each of the plural light-emitting devices so as to form the specular reflection light-emitting unit which comprises plural specular reflection light-emitting devices.

22. The method of claim 12, wherein the indication region comprises an edge, one of the specular reflection camera unit and the specular reflection light-emitting unit is formed on an extension direction of the edge.
